(19) United States
(12) Patent Application Publication
(10) Pub. No.: US 2021/0198866 A1
(43) Pub. Date: Jul. 1, 2021

(54) Method for the Automated Control of an Excavator

(71) Applicant: Robert Bosch GmbH, Stuttgart (DE)

(72) Inventors: Kai Liu, Asperg (DE); Udo Schulz, Vaihingen/Enz (DE)

(21) Appl. No.: 17/057,467

(22) PCT Filed: Apr. 10, 2019
(86) PCT No.: PCT/EP2019/059130

§ 371 Date: Nov. 20, 2020

(30) Foreign Application Priority Data
May 30, 2018 (DE) 10 2018 208 642.7

(51) Int. Cl. E02F 3/43; E02F 9/20; E02F 9/26; G01C 21/00; G05D 1/02

(52) U.S. Cl. CPC E02F 3/437; E02F 9/2045; E02F 9/262; G05D 2201/0202; G05D 1/0246; G05D 1/0274; G01C 21/005

(57) ABSTRACT

A method for the automated control of an excavator having an excavator bucket, which is movably connected to the excavator by an arm includes, at the beginning, a semantic map having the coordinates of a ground to be changed is provided for the excavator and a material processing trajectory is provided for the excavator. The material processing trajectory is determined from the semantic map and comprises a starting point and a direction for the processing of the ground by the excavator bucket. Then the starting point is traveled to. Subsequently, a movement trajectory is calculated on the basis of the starting point by the semantic map and an excavator bucket trajectory is calculated by the semantic map. A work process is carried out in accordance with the material processing trajectory, the movement trajectory, and the excavator bucket trajectory, and in the end the semantic map is updated.

The present invention relates to a method for the automated control of an excavator using a semantic map. The invention also relates to an electronic control unit, which is set up to carry out the method as claimed in the invention.

### PRIOR ART

An excavator with an excavator bucket, which is movably connected to the excavator by an arm, has been known for a long time. Nowadays, various assistance functions are used to facilitate the operation of excavators. An end position damper prevents the cylinders of the arm from striking the mechanical stops. In addition, working space limits are predetermined, which may not be exceeded by the excavator. This working space limitation prevents the excavator or the excavator bucket from striking obstacles, such as a wall. With coordinate control, the excavator operator does not control the individual cylinders of the arm but specifies the path of the excavator bucket directly. For the assistance systems mentioned above, sensors are required to determine the position of the arm and the excavator bucket. This primarily includes inertial sensors and optical sensors, such as cameras.

Moreover, there are efforts to automate the manner of operation of excavators. In addition to the movement of the excavator itself, the focus here is primarily on the working movement of the excavator bucket.

### DISCLOSURE OF THE INVENTION

A method for the automated control of an excavator with an excavator bucket is proposed, wherein the excavator bucket is movably connected to the excavator by an arm. The method includes the following steps:

At the beginning of the method, a semantic map with the coordinates of ground to be modified is provided for the excavator. A semantic map represents a metric map containing, in addition to geometric information, semantic designations for objects from sensor data obtained from optical sensors (classified objects). The optical sensors are preferably cameras and can be connected to the excavator and/or to an infrastructure in the vicinity of the excavator. For example, ground on which the excavator is driven is characterized as a floor and a surface that protrudes upwards perpendicularly to the ground is characterized as a wall. The coordinates of the ground to be changed are preferably calculated from a model and entered into the semantic map. The model can be a so-called “building information model” (BIM), in which data for a building are digitally modelled, so that the structure is available as a virtual model. The ground to be changed can be a depression intended in the ground which is to be excavated. In this case, the intended depression can be characterized as an excavation pit. On the other hand, the ground to be changed can be an intended elevation, which can be heaped up and which can be characterized as an embankment, for example. In other words, the semantic map has the coordinates and from this result the position and dimensions of the excavation pit that is to be excavated or the embankment that is to be raised. Three-dimensional coordinates (3D coordinates) are preferably used, which reflect the position, the length, the width, and the depth of the excavation pit or the height of the heap or the shape of the elevation.

Optionally, in addition to the semantic map, a global map with the coordinates of the ground to be changed can also be provided for the excavator. This global map shows the position of the ground to be changed in a larger area, for example within the entire construction site. Both maps are preferably merged, which means that the objects in the semantic map are also referenced globally. The locations of planned and existing objects in the global map can be transferred to the semantic map. This allows the excavator to orient itself using the semantic map and, for example, by means of optical sensors. In this case, a receiver for a global navigation satellite system (GNSS) on the excavator can be dispensed with.

In addition, a material processing trajectory is provided for the excavator. The material processing trajectory is determined from the semantic map, if necessary including the global map, and includes a starting point and a direction for processing the ground with the excavator bucket. Thus, at least a rough orientation for a first process or a more precise specification of the three-dimensional material flow in the sense of the material removal or material addition in relation to the ground by the excavator bucket is established. A more detailed description is given below in relation to the case of excavation of an excavation pit and the case of building up an embankment. When determining the material processing trajectory, working properties of the excavator bucket are taken into account, such as the movement capabilities, the bucket capacity, the working width and/or the working depth or the working height.

Subsequently, a drive unit, such as an engine, of the excavator is controlled, so that the excavator arrives at the starting point specified by the material processing trajectory. In doing so, the excavator can advantageously move to the starting point independently by means of route planning. For route planning, the excavator can use a model of the environment, preferably the “building information model” mentioned above. Alternatively, route planning can take place in an electronic control unit of the excavator. In this case, route planning can be carried out by using fixed lanes and/or navigable free areas. The free areas can be determined from the sensor data of the optical sensors. Alternatively, the free areas can be determined from the semantic map. When determining the free areas, a distinction is made between driving movement and movement windows for the working tools. The free areas or the driving lanes are specially designed for the excavator and can be different from others, such as for a transport vehicle. If an obstacle enters the route at the starting point, the route planning is adjusted accordingly to bypass the obstacle.

Depending on the starting point, using the semantic map, and optionally depending on the global map, a movement trajectory is calculated, along which the excavator moves for or during the processing of the ground, wherein both the driving movement and the working movement are reproduced. In addition, a 3D profile of the environment can be determined from the sensor data of the optical sensors, which can be incorporated into the calculation of the movement trajectory. When calculating the movement trajectory, the route planning mentioned above can be used. If an obstacle appears within the excavator bucket trajectory, the movement trajectory is adjusted accordingly to bypass the obstacle. Here too, working properties such as the movement capabilities, the bucket capacity, the working width and/or the working depth or the working height of the excavator bucket and, where appropriate, the dimensions of the excavation pit or the embankment are taken into account.

Furthermore, the semantic map is used to calculate or plan an excavator bucket trajectory, which reflects the movement of the excavator bucket. The calculation of the excavator bucket trajectory is preferably carried out by an electronic control unit of the excavator. Using the excavator bucket trajectory and the position of the excavator bucket, the excavator bucket is oriented, and the cutting edge of the excavator blade is precisely controlled. A more detailed description is given below in relation to the case of the excavation of an excavation pit and the case of building up an embankment. In addition, a 3D profile of the environment can be determined from the sensor data of the optical sensors, which is incorporated into the calculation of the excavator bucket trajectory. Here too, work properties such as the movement capabilities, the bucket capacity, the working width and/or the working depth or the working height of the excavator bucket and, where appropriate, the dimensions of the excavation pit or the embankment are taken into account.

Once the trajectories have been determined, the excavator carries out a work step according to the material processing trajectory, the movement trajectory, and the excavator bucket trajectory. For this purpose, the excavator receives a control signal from the control unit controlling the method as claimed in the invention. More specifically, the excavator and the excavator bucket position themselves depending on the material processing trajectory and then the excavator bucket moves along the material processing trajectory to either pick up or unload material. Then the excavator bucket is moved along the excavator bucket trajectory to a new processing point or to the same processing point. Here the excavator bucket is again moving along the material processing trajectory. These steps can be repeated multiple times until the ground has been processed in the predetermined locations which can be reached from the current position of the excavator. Finally, the excavator moves along the movement trajectory towards a new position and starts again.

Typically, the ground has changed after the work step. To adapt to the changed ground, it is provided that the excavator bucket trajectory is recalculated after carrying out the work step. Preferably, an obstacle that arises during the processing of the ground while carrying out work step is taken into account in the recalculation of the excavator bucket trajectory.

Finally, the semantic map is updated based on the sensor data of the optical sensors. The excavated material or the heaped up material can be seen in the sensor data. In the course of this, the excavator bucket trajectory can be used with knowledge of the previously excavated material or of the heaped up material, the updated semantic map, the material processing trajectory and/or the working characteristics, in particular the bucket capacity of the excavator bucket. The control of the excavator bucket can be optimized so that a lot of material can be accommodated without any material being lost, that material is not just moved but is actually transported and that the excavator bucket has to collect as little as possible again.

According to one aspect, the automatic control of the excavator is used for excavating part of the ground. In other words, the excavator and the excavator bucket are controlled so that material is removed from an excavation pit. This allows a large part of the tasks to be carried out by the excavator to be covered. In this case, the material processing trajectory described above is a material removal trajectory, which includes as the starting point the cutting point of the excavator bucket and the direction of movement of the excavator bucket. The material removal trajectory describes the progression of the material decrease in the excavation pit and serves as a rough orientation of the excavator bucket for the moment of cutting to pick up the material. Furthermore, the excavator bucket trajectory is an excavator bucket pick-up trajectory, which indicates the movement of the excavator bucket for cutting and picking up material. Accordingly, the work step will be carried out according to the material removal trajectory, the movement trajectory described above and the excavator bucket pick-up trajectory.

In addition, an excavator bucket unloading trajectory can be calculated. The excavator bucket unloading trajectory describes a movement of the excavator bucket for unloading at an unloading location the material which was picked up in the course of the work step described above. The unloading location can either be a fixed location or, for example, a transport vehicle and can be chosen in a known manner. The excavator bucket unloading trajectory is preferably calculated from the position of the excavator, the position of the unloading location and the starting point. Also, the aforementioned working characteristics of the excavator bucket can be taken into account in the calculation of the excavator bucket unloading trajectory. After the material has been removed, a work step is carried out to unload the excavator bucket at the unloading location at least in accordance with the excavator bucket unloading trajectory. As a result, the excavation of the material from the excavation pit and the subsequent unloading of the material can be jointly controlled automatically. Preferably, the movement of the excavator bucket is on the excavator bucket extraction trajectory provided from the unloading location to the new cutting location if the material removal was entirely carried out according to the material removal trajectory on the former excavator bucket pick-up trajectory, or to the same cutting location if the material removal according to the material removal trajectory on the former excavator bucket pick-up trajectory was not carried out fully or was not completed.

In order not to cause any damage in the vicinity of the excavation pit, it is provided that the material removal trajectory and/or the excavator bucket pick-up trajectory are calculated in such a way that a pre-specified excavation window is not exceeded by the excavator bucket. By means of the optical sensors, it is monitored whether the excavator bucket is approaching the boundary of the excavation window. Before the excavator bucket leaves the excavation window, the excavator bucket is decelerated, wherein the excavator bucket preferably comes to a halt without overshooting. The excavation window can be specified either by the building information model or stored in the electronic control unit of the excavator, in particular in the form of a working space limitation.

When calculating the material removal trajectory, it is taken into account that the excavator can drive into the excavated part of the ground, i.e. the excavation pit, and out again. Similarly, in the calculation of the excavator bucket pick-up trajectory and/or in the calculation of the excavator bucket unloading trajectory, it is taken into account whether the excavator enters the excavation pit or not. This is mainly dependent on the dimensions of the excavation pit and the specification of the excavator, in particular the dimensions of the excavator and the reach of the arm. In particular, for the material removal trajectory it is taken into account that at least one section of the sides of the excavation pit is processed in such a way that the excavator can drive on this section. As an example, a ramp is mentioned, over which the excavator can drive out of the excavation pit. It is foreseen that at least the final work step of the excavation is carried out outside the excavation pit to avoid the excavator being trapped in the excavation pit. In the above example, the excavator first drives over the ramp out of the excavation pit before it excavates the ramp itself from outside the excavation pit.

According to another aspect the automatic control of the excavator is used to raise the ground. In other words, the excavator and the excavator bucket are controlled in such a way that material is heaped up to form an embankment, for example. This means that another large part of the tasks to be carried out by an excavator can be covered. In this case, the material processing trajectory described above is a material addition trajectory, which includes the unloading location of the excavator bucket and the direction of movement of the excavator bucket. The material addition trajectory describes the progression of the material addition at the unloading location. Furthermore, the excavator bucket trajectory is an excavator bucket unloading trajectory, which specifies the movement of the excavator bucket for unloading material which has been picked up by the excavator bucket. Accordingly, the work step is carried out according to the material addition trajectory, the movement trajectory described above and the excavator bucket unloading trajectory.

The automatic control of the excavator for the excavation of part of the ground and the automatic control of the excavator to raise the ground level can be used separately from each other as well as jointly. In the latter case, material is picked up during excavation from the excavation pit and unloaded at another location, the unloading location, to raise the ground level. It is clear that the unloading location for the raising of the ground level is a fixed location and is therefore not a transport vehicle in the sense described above.

The calculation of the trajectories mentioned above can be carried out at least partially by the building information model. Preferably, the actual state of the ground to be processed is determined by means of the optical sensors and compared with a target state of the building information model. This comparison can be used to evaluate the performance of the building information model on the one hand and can be used to improve the building information model on the other hand. Alternatively, the calculation of the trajectories can be carried out by a control unit of the excavator.

Material that has fallen from the excavator bucket and/or has only been moved can be detected and picked up by repeating the trajectories.

The previous method relates to one excavator. However, multiple excavators can also be used simultaneously on the same construction project and in particular with the same task. In this case, the trajectories for several excavators are calculated at the same time. When calculating trajectories, care must be taken to ensure that collisions and mutual obstructions are avoided. Where sections of trajectories of two or more excavators are close to each other or intersect, care must be taken to ensure that the excavators are not in those sections at the same time.

An electronic control system is set up to perform the method described above. This may include a computer program that performs every step of the method. It allows the implementation of the method in a conventional electronic control unit without having to make structural changes. For this purpose, it can be stored on the machine-readable memory medium.

### BRIEF DESCRIPTION OF THE DRAWINGS

Exemplary embodiments of the invention are represented in the drawings and described in detail in the following description.

FIG. 1 shows a schematic representation of a plan view of an excavator and an excavation pit in which a movement trajectory and an excavator bucket pick-up trajectory according to an embodiment of the invention are plotted.

FIG. 2 shows the schematic representation from figure with an additional obstacle in the route of the excavator.

FIGS. 3a-c each show a schematic representation of a side view of the excavator and the excavation pit from FIG. 1, in which a material removal trajectory is plotted according to an embodiment of the invention.

FIGS. 4a-c show the schematic representation from FIG. 3 with an additional obstacle in the excavation pit.

FIG. 5 show the schematic representation from FIG. 3 with another excavator.

### EXEMPLARY EMBODIMENTS OF THE INVENTION

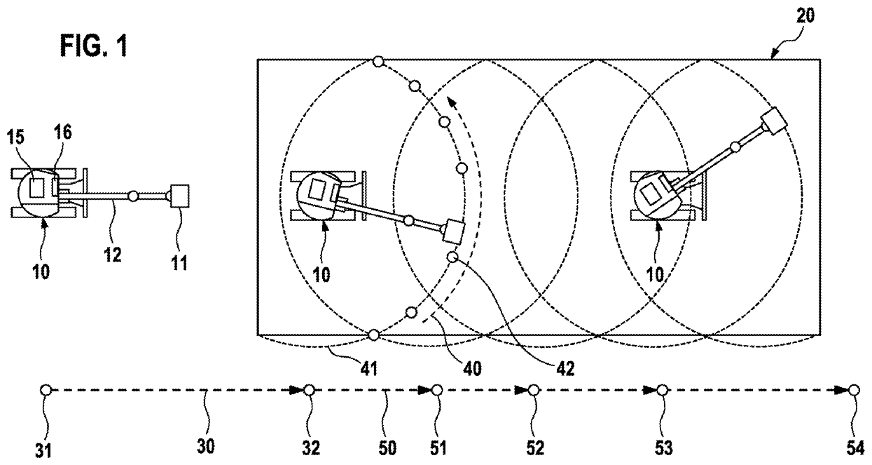

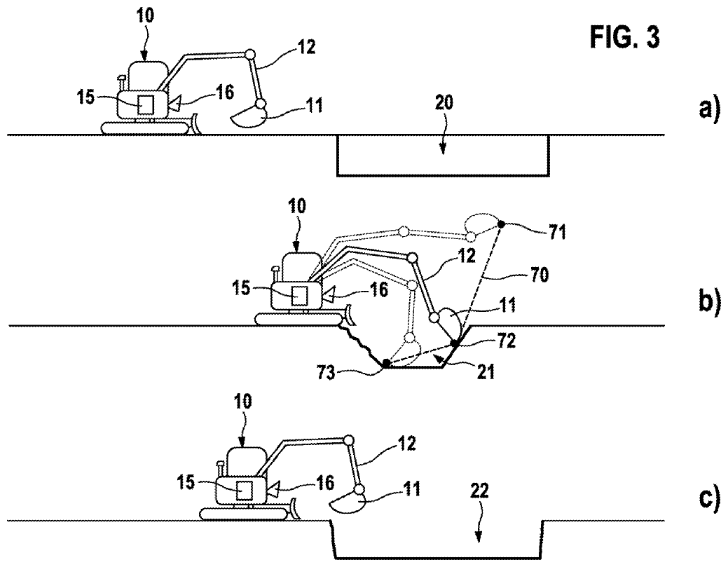

FIG. 1 shows a schematic representation of a plan view of an excavator 10 and an excavation pit 20. In this illustration, the same excavator is shown 10 at several time points. The excavator 10 has an excavator bucket 11, which is movably connected to the excavator 10 by an arm 12 (reference characters are shown only for one excavator for clarity). Furthermore, the excavator 10 has an electronic control unit 15 and associated optical sensors in the form of cameras 16—of which only one is shown here, but several can be present. The electronic control unit 15 of the excavator 10 is provided with a semantic map based on a building information model and optionally with a global map (not shown), in which coordinates of the intended excavation pit 20 are entered. In particular, the maps are merged, and the global position of planned and existing objects is transferred to the semantic map. On the basis of the semantic map and a position of the excavator 10, a material removal trajectory—which is described in detail in connection with FIG. 3—is provided. The excavator 10 drives itself on a route 30 determined by means of route planning from a starting position 31 of the excavator to a starting position 32 specified by the material processing trajectory. Route planning can be run on the electronic control system 15 or can use the building information model. The route 30 runs on designated lanes or on navigable free areas, which are detected by the cameras 16 or determined from the semantic map.

An excavator bucket pick-up trajectory 40 is also plotted in FIG. 1, along which the excavator bucket 11 moves, wherein the excavator bucket 11 can excavate an area marked by the circular section 41 from the starting position 32 depending on the length of the arm and the mobility. As the starting point for the material removal trajectory, cutting locations 42 are arranged on the circular section 41 along the excavator bucket pick-up trajectory 40, on which the excavator bucket 11 cuts into the ground in a predetermined direction and removes material. A more detailed description of this is given with reference to FIG. 3. The starting locations 42 are dependent on the movement capabilities, the bucket capacity and above all the working width of the excavator bucket. The excavator 10 excavates material with the excavator bucket 11 at each cutting location 42 according to the material removal trajectory—which is described in detail with reference to FIG. 3. In embodiments not shown here, the excavator bucket 11 then moves along an excavator bucket unloading trajectory to an unloading location, which can either be fixed or may be a transport vehicle, such as a truck. The excavator bucket pick-up trajectory is recalculated after carrying out the work step. Subsequently, the excavator bucket 11 moves along the excavator bucket pick-up trajectory 40 to the next cutting point 42 and removes material there again.

If the marked area is excavated in this way, the excavator 10 travels along the plotted movement trajectory 50 to the respective next point 51, 52, 53 until it reaches an end point 54 and performs the excavation described above at these locations in each case. During this. the excavator 10 moves within the already excavated section of the excavation pit 20. The movement trajectory 50 can run on the electronic control unit 15 or can use the building information model and can run along designated lanes or on navigable free areas, which are detected by the cameras 16 or determined from the semantic map. The end point is chosen so that the excavator 10 is standing outside the excavation pit 20 when it carries out the last excavation. For reasons of clarity, for the further points 51, 52, 53, 54 only the circular sections are shown over which the excavator bucket can move (without separate reference characters), but not the respective excavator bucket pick-up trajectories 40 themselves. It can be seen that the excavator bucket 11 can also excavate material from on the rear of the excavator 10—contrary to the preferred direction of travel of the excavator 10. This is particularly important for the end point 54, as the excavator 10 can excavate the remaining designated area here when it has left the excavation pit 20.

In the following, the same components are designated with the same reference characters, so that their repeated description is omitted below.

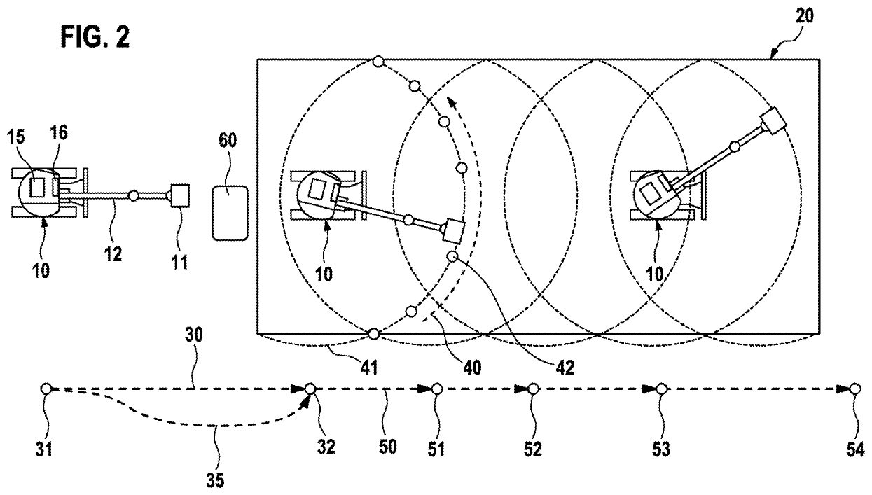

It should be noted that in FIGS. 1 and 2, the route 30 and the movement trajectory 50 are shown below the excavator 10 and the excavation pit 20. This presentation was chosen for reasons of clarity in order to show the route 30, the movement trajectory 50 and especially the points 31, 32, 51, 52, 53, 54 clearly recognizably on the route 30 and on the movement trajectory 50, respectively. The route 30 and the movement trajectory 50 run in the application through the three positions at which the excavator 10 is shown in FIGS. 1 and 2 in each case. In practice, the route and the movement trajectory 50 usually run two-dimensionally in the plane shown and three-dimensionally if necessary.

FIG. 2 also shows a schematic representation of a top view of the excavator 10 and the excavation pit 20. Compared to FIG. 1, FIG. 2 shows an obstacle 60 located between the excavator 10 and the starting position 32. The obstacle 60 is detected by the cameras 16 of the excavator 10 and the route plan is adjusted so that the original route 30 is changed to a new Route 35, along which the excavator 10 moves from the starting position 31 to the starting position 32.

FIGS. 3a-c each show a schematic representation of a side view of the excavator 10 and the excavation pit 20 from FIG. 1. In FIG. 3a the excavator 10 is shown at the starting point 31 and the planned excavation pit is shown. The excavator moves from the starting position 31 to the starting position 32, which it reaches in FIG. 3b. In FIG. 3b, moreover is shown a material removal trajectory 70, along which the excavator bucket 11 is moved from an initial position 71, via a position 72 at the cutting point to an end position 73. The material removal trajectory 70 therefore includes, in addition to the starting point, which is therefore the cutting point 42 (see FIG. 2), also the direction in which to cut the material from the ground by the excavator bucket 11 at the cutting point. By cutting out the material, the section 21 of the excavation pit shown is obtained. FIG. 3c shows the excavation pit 22, which in this exemplary embodiment essentially corresponds to the planned excavation pit 20. The actual excavation pit 22 is captured by the camera 16 and the actual state of the actual excavation pit 22 is compared with the intended state of the planned excavation pit 20. This comparison can be used to evaluate the performance of the building information model on the one hand and to improve the building information model on the other hand.

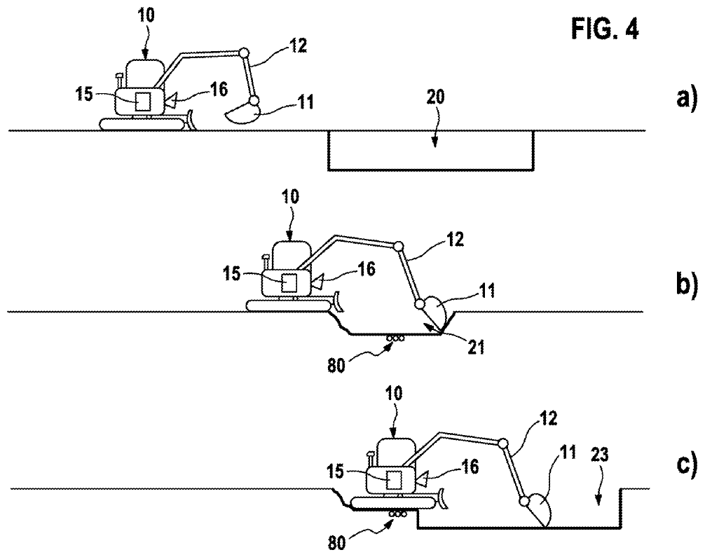

FIGS. 4a-c also show a schematic representation of a side view of the excavator 10 and the excavation pit 20. FIG. 4a corresponds to FIG. 3a. Compared to FIG. 3b, in FIG. 4b an obstacle 80—for example, a cable—is shown in the excavation pit 20, which emerges when excavating the section 21 shown. The obstacle 80 is taken into account in the calculation of the excavator bucket trajectory 40, the movement trajectory 50 and/or the material processing trajectory 70. FIG. 4c now shows a changed actual excavation pit 23, which is displaced in comparison to the planned excavation pit but no longer contacts the obstacle 80. The dimensions of the changed actual excavation pit 23 correspond to those of the planned excavation pit 20. The displacement of the actual excavation pit 23 is carried out in accordance with the building information model and can also be avoided if the excavation pit 20 is excavated, for example, in a precisely prescribed location. Here, too, the changed actual excavation pit is captured by the camera 16 and the building information model is adapted according to the new position of the actual excavation pit 23. Moreover, it is shown again in FIG. 4c that the excavator 10 can be within the already excavated section 21 and can move out of this again.

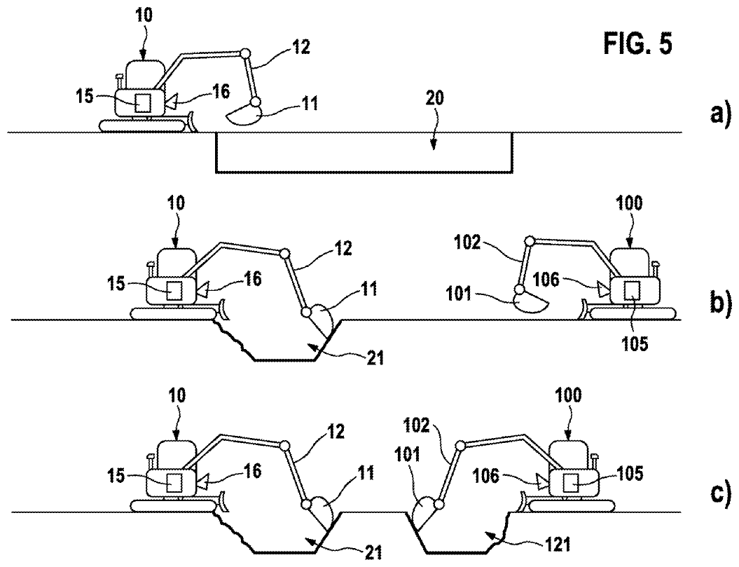

FIGS. 5a-c also show a schematic representation of a side view of the excavator 10 and the excavation pit 20. FIG. 5a corresponds to FIG. 3a. In comparison to FIG. 3b, in FIG. 5b an additional excavator 100 is shown, which corresponds to the excavator 10, and also includes an excavator bucket 101, an arm 102, an electronic control unit 105 and cameras 106. The additional excavator 100 is used to excavate the excavation pit 20 in cooperation with the already described excavator 10. For the additional excavator 100, similarly to the excavator 10, an excavator bucket trajectory, a movement trajectory and a material processing trajectory are also calculated. For the description of the operation of the additional excavator 100, reference is made to the description of the excavator 10. FIG. 5c shows the section 21 of the excavation pit which was excavated by the excavator 10 and section 121 of the excavation pit which was excavated by the additional excavator 100.

In other exemplary embodiments which are not shown, the automatic control of the excavator 10 is used to raise the ground level. Here, a material addition trajectory is used instead of the material removal trajectory 70, which includes the unloading location of the material from the excavator bucket 11 and the direction of the movement of the excavator bucket 11, as well as an excavator bucket unloading trajectory instead of the excavator bucket pick-up trajectory 40, which specifies the movement of the excavator bucket 11. Moreover, the movement trajectory 20 is adjusted accordingly. The work steps are then carried out according to the material addition trajectory, the excavator bucket unloading trajectory and the adapted movement trajectory.

1. A method for the automated control of an excavator with an excavator bucket, which is movably connected to the excavator by an arm, comprising:
providing a semantic map with coordinates of ground to be changed for the excavator;
determining a material processing trajectory for the excavator from the semantic map, the material processing trajectory including a starting point and a direction for processing the ground by the excavator bucket;
controlling a drive unit of the excavator for approaching the starting point;
calculating a movement trajectory based on the starting point based on the semantic map;
calculating an excavator bucket trajectory based on the semantic map;
outputting a control signal to carry out a work process according to the material processing trajectory, the movement trajectory, and the excavator bucket trajectory; and
updating the semantic map.

2. The method as claimed in claim 1, further comprising:
excavating at least part of the ground using the automated control of the excavator,
wherein the material processing trajectory is a material removal trajectory which includes as a processing starting point a cutting point of the excavator bucket and a direction of movement of the excavator bucket,
wherein the excavator bucket trajectory is an excavator bucket pick-up trajectory which specifies the movement of the excavator bucket, and
the work process is carried out according to the material removal trajectory, the movement trajectory, and the excavator bucket pick-up trajectory.

3. The method as claimed in claim 2, further comprising:
calculating the material removal trajectory and/or the excavator bucket pick-up trajectory such that an excavation window is not exceeded by the excavator bucket.

4. The method as claimed in claim 2, further comprising:
calculating an excavator bucket unloading trajectory from a position of the excavator, a position of an unloading location, and the starting point; and
after the excavating, unloading the excavator bucket at least according to the excavator bucket unloading trajectory.

5. The method as claimed in claim 4, further comprising:
calculating the material removal trajectory, the excavator bucket pick-up trajectory, and/or the excavator bucket unloading trajectory based on the excavator being configured to drive into and out of an excavated part of the ground,
wherein a last work process is carried out from outside the excavated part of the ground.

6. The method as claimed in claim 1, further comprising:
using the automated control of the excavator to raise a level of the ground,
wherein the material processing trajectory is a material addition trajectory, which includes an unloading location of the excavator bucket and a direction of movement of excavator bucket,
wherein the excavator bucket trajectory is an excavator bucket unloading trajectory specifying movement of the excavator bucket, and
wherein the work process is carried out according to the material addition trajectory, the movement trajectory, and the excavator bucket unloading trajectory.

7. The method as claimed in claim 1, further comprising:
providing a global map with the coordinates of the ground to be moved for the excavator; and
calculating the excavator bucket trajectory, the movement trajectory, and the material processing trajectory based on the global map.

8. The method as claimed in claim 1, wherein the excavator moves itself independently to the starting position according to route planning by a model of an environment or by an electronic control unit of the excavator.

9. The method as claimed in claim 1, further comprising:
determining a 3D profile of an environment using optical sensors; and
using the 3D profile of the environment to calculate the movement trajectory and/or to calculate the excavator bucket trajectory.

10. The method as claimed in claim 1, further comprising:
calculating the excavator bucket trajectory, the movement trajectory, and the material processing trajectory based on working properties of the excavator bucket.

11. The method as claimed in claim 1, further comprising:
recalculating the excavator bucket trajectory after carrying out the work process.

12. The method as claimed in claim 1, further comprising:
calculating the excavator bucket trajectory, the movement trajectory, and/or the material processing trajectory based on emerging obstacles.

13. The method as claimed in claim 1, further comprising:
calculating the excavator bucket trajectory, the movement trajectory, and the material processing trajectory using a building information model or by an electronic control unit of the excavator.

14. The method as claimed in claim 1, further comprising:
calculating the excavator bucket trajectory, the movement trajectory, and the material processing trajectory for multiple excavators,
wherein the multiple excavators carry out corresponding work process according to the calculated excavator bucket trajectories, the movement trajectories, and the material processing trajectories.

15. The method as claimed in claim 1, wherein an electronic control device is configured to automatically control the excavator according to the method.
